(19) United States
(12) Patent Application Publication
(10) Pub. No.: US 2013/0026687 A1
(43) Pub. Date: Jan. 31, 2013

(54) GAS SPRING WITH DYNAMICALLY CONTROLLABLE DAMPING

(71) Applicant: MIRO MILINKOVIC, Acton (CA)

(72) Inventor: MIRO MILINKOVIC, Acton (CA)

(21) Appl. No.: 13/191,822

(22) Filed: Jul. 27, 2011

(51) Int. Cl. F16F 9/02; F16F 9/19

(52) U.S. Cl. 267/124

(57) ABSTRACT

A gas spring suitable for controlling motion of a linear power generator or a linear machine. According to an embodiment, the gas spring comprises a cylinder and a pressure control network. The cylinder comprises two pistons in a coaxial arrangement and three controllable gas volumes or chambers. Each of the pistons includes a piston rod or shaft that is configured to couple to respective drive shaft(s) on the linear power generator. The pressure control network is operatively coupled to each of the three gas volumes and configured with a controller to control the gas pressure in the gas volumes to vary the resistance of the pistons to the movement of the respective drive shaft(s) on the linear power generator. According to another embodiment, the cylinder comprises one piston and two controllable gas volumes or chambers operatively coupled to the pressure control network.

### FIELD OF THE INVENTION

The present invention relates to a gas spring, and more particularly, to a gas spring configured for dynamically controlling the stiffness and/or rebound, and is suitable for use with a linear movement machine or generator.

### BACKGROUND OF THE INVENTION

Linear reciprocating machines are typically subject to two problems. The first concerns efficient energy storage and release during the acceleration and de-acceleration cycles. The second concern is the prevention or reduction of mechanical vibrations. Mechanical vibrations can reduce efficiencies and are typically directed or transmitted to the base of the machine.

Accordingly, there remains a need for improvements in the art.

### BRIEF SUMMARY OF THE INVENTION

The present invention comprises embodiments of a gas spring and/or a gas spring configured with a mechanism for controlling the dampening force, i.e. stiffness, and/or rebounding force of the gas spring.

According to an embodiment, the present invention provides a gas spring with dynamically controllable dampening force and/or rebounding force suitable for use with a linear reciprocating machine or generator.

According to another embodiment, the present invention provides a method for dynamically controlling a gas spring.

According to another embodiment, the present invention provides a gas spring for linear reciprocating piston power generator.

According to a first aspect, there is provided a gas spring comprising a cylinder; a first piston and a second piston configured in a substantially co-axial arrangement inside the cylinder, the first piston comprising a piston face and including a rod configured to be coupled to a first movable component, and the second piston comprising a piston face and including a rod configured to be coupled to a second movable component, and the first piston being configured to move in response to movement of the first movable component, and said second piston being configured to move in response to movement of said second movable component; the cylinder comprising first, second and third chambers; the first chamber being defined by the volume between the first piston and an end wall of the cylinder; the second chamber being defined by the volume between the faces of the first and the second pistons; the third chamber being defined by the volume between the second piston and an opposing end wall of the cylinder; the first chamber including an input port and the third chamber including an input port and the input ports being coupled to a first pressure control stage; the second chamber including an input port and the input port being coupled to a second pressure control stage; and a controller operatively coupled to the first and the second pressure control stages, and the controller being configured to generate one or more gas pressure forces in the first, the second or the third chambers and the gas pressure forces being applied to the first and the second pistons to vary the moving resistance of the first and the second piston rods.

According to another aspect, there is provided a method for controlling the damping in a gas spring, the method comprising method for controlling a gas spring to dampen linear movement of a shaft, the gas spring comprising a cylinder and a piston configured to move linearly inside the cylinder, and the piston having a first face defining a first volume with an end wall of the cylinder and a second face defining a second volume with another end wall of the cylinder and the second face including a rod for coupling to the shaft, the method comprising the steps of: pressurizing the first volume with a compressed gas; pressurizing the second volume with a compressed gas; establishing a gas charge pressure based on the pressurization of the first and second volumes; and varying the gas charge pressure to change resistance of the piston to movement of the shaft.

Other aspects and features according to the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present invention, and in which:

FIG. 1 shows a gas spring according to an embodiment of the present invention; and

FIG. 2 shows in flowchart form a process for controlling the gas spring of FIG. 1 according to an embodiment of the present invention;

Like reference numerals indicate like or corresponding elements in the drawings.

### DETAILED DESCRIPTION OF THE EMBODIMENTS

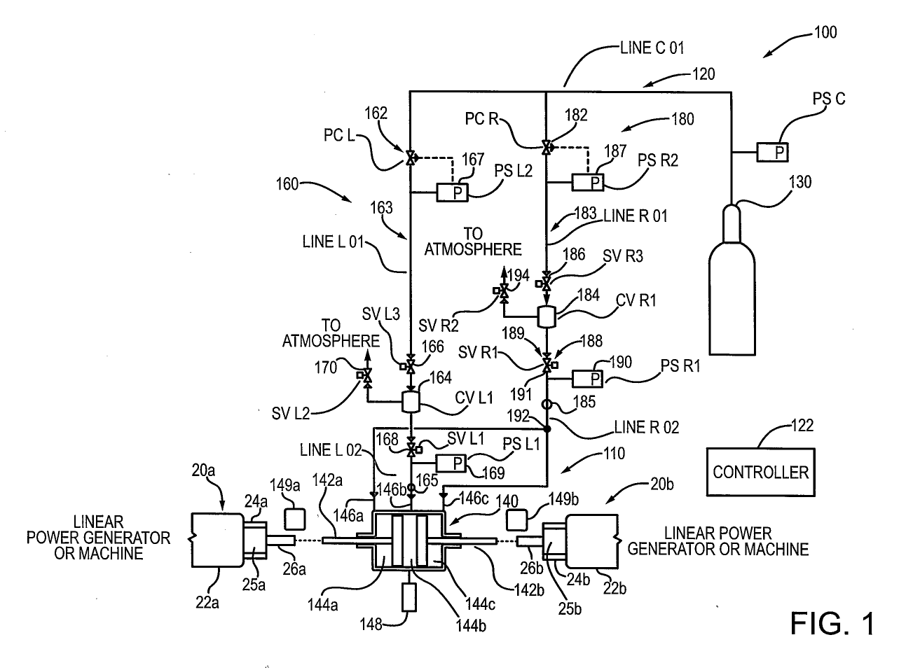

Reference is first made to FIG. 1, which shows a gas spring system according to an embodiment of the invention. The gas spring system is indicated generally by reference 100 and according to an exemplary embodiment is configured to operate with a linear reciprocating machine or a linear power generator. While the gas spring 100 according to embodiments of the present invention is described in the context of a linear reciprocating machine, or a linear power generator, it will be appreciated that the gas spring is suitable for other applications requiring a spring or damping force that can according to an aspect of the invention be dynamically controlled as also described in more detail below.

As shown in FIG. 1, the gas spring system 100 generally comprises a gas spring assembly 110, a pressure control network 120, a controller 122 and a gas supply system 130.

In the context of the present exemplary implementation, the gas spring system is configured to work with a pair of linear power generators 20 in a balanced configuration. Each of the linear power generators 20 comprises a cylinder assembly 22, indicated individually by references 22a and 22b, an electromagnetic coil 24, indicated individually by references 24a and 24b. The cylinder assembly 22 comprises a first piston and a second piston configured in a substantially co-axial arrangement, the first piston is configured to move in a first direction in response to application of a pressurized gas, and the second piston is configured to move in a second direction in response to application of a pressurized gas, and the second direction is substantially opposite to the first direction. The cylinder assembly 22 further includes a first drive shaft 26, indicated individually by references 26a and 26b in FIG. 1, which is coupled to the piston at one end and having another end configured for coupling to an electromagnetic component 25, indicated individually by references 25a and 25b, and the first drive shaft 26 is configured to move the electromagnetic component 25 in relation to the electromagnetic coil 24 in response to movement of the first piston so as to induce a voltage in the electromagnetic coil 24. The cylinder assembly 22 also includes a second drive shaft (not shown) coupled to the second piston at one end and having another end configured for coupling to, an electromagnetic component 25, and the second drive shaft is configured to move the electromagnetic component 25 in relation to the electromagnetic coil 24 in response to movement of the second piston so as to induce a voltage in the electromagnetic coil 24. As shown in FIG. 1, the respective ends of the drive shafts 26a and 26b are configured to be coupled to the respective end of the pistons 142a and 142b. As will be described in more detail below, the gas spring system 100 can be configured to dampen the movement of the drive shafts 26 on the respective cylinder assemblies 22, and the amount of dampening force, i.e. resistance, and/or rebounding force can be controlled and varied, as will also be described in more detail below.

The gas spring assembly 110, according to an embodiment, comprises a gas spring cylinder or body 140, and first and second pistons 142, indicated individually by references 142a and 142b, respectively. The first and second pistons 142 are configured to form a left cylinder volume or chamber 144a, a center cylinder volume or chamber 144b and a right cylinder volume or chamber 144c inside the gas spring cylinder 140. The gas spring cylinder 140 includes a left port 146a for coupling the left cylinder volume 144a to the process control network 120, a center port 146b for coupling the center cylinder volume 144b to the process control network 120, and a right port 146c for coupling the right cylinder volume 144c to the process control network 120. As also shown in FIG. 1, the gas spring assembly 110 includes a temperature sensor indicated generally by reference 148. The gas spring assembly 110 can also include sensors 149a and 149b, for example, laser distance sensors, configured for sensing the movement or travel of the respective pistons 142a and 142b.

As shown in FIG. 1 and according to an embodiment, the pressure control network 120 comprises a first pressure control stage indicated generally by reference 160 and a second pressure control stage indicated generally by reference 180. As will be described in more detail below, the first pressure control stage 160 is configured to control the pressure in the central cylinder volume 144b of the gas spring cylinder 140, and the second pressure control stage 180 is configured to control the pressure in the left 144a and right 144c cylinder volumes of the gas spring cylinder 140.

The first pressure control stage 160 comprises a pressure controller 162 and a pressure control line 163. The pressure controller 162 includes a solenoid valve and a pressure sensor 167 and is operatively coupled to the output of the gas supply cylinder 130. The pressure control line 163 comprises a compressed gas or air volume cylinder 164 and an output port 165. The output of the pressure controller 162 is operatively coupled to the input of the compressed air volume cylinder 164 through a solenoid valve 166. The output port 165 is coupled to the output of the compressed gas or air volume cylinder 164 and then to input port 146b of the center cylinder volume 144b through a solenoid valve 168. The solenoid valve 168 includes a pressure sensor indicated generally by reference 169. As shown in FIG. 1, the first pressure control stage 160 also includes a second solenoid valve 170 coupled to an output port on the compressed gas volume cylinder 164. The solenoid valve 170 is operatively coupled to the compressed gas volume cylinder 164 and is configured to controllably release compressed gas to the atmosphere or an exhaust chamber (not shown), as will be described in more detail below.

In known manner, the solenoids 162, 166, 168 and 170 are operatively coupled to the controller 122 and configured to be responsive to control signals, status request signals and other types of signals generated by the controller 122. Similarly, the pressure sensors 163 and 169 are operatively coupled to the controller 122. The sensors 163 and 169 are configured to output pressure readings and other signals to the controller 122. The sensors 163 and 169 can also be configured to be responsive to sensor reading, status, reset and other control signals issued by the controller 122. The controller 122, in turn, is configured to provide the functionality and process control functions as described herein, and according to one embodiment comprises a microprocessor-based device that operates under stored program control, for example, comprising firmware, software, code modules or components, functions, objects, programmable logic, etc. The specific implementation, programming and configuration details are within the understanding of one skilled in the art.

The second pressure control stage 180 comprises a pressure controller 182 (and a pressure control line 183. The pressure controller 182 includes a solenoid valve and a pressure sensor 187 and is operatively coupled to the output of the gas supply cylinder 130. The pressure control line 183 comprises a compressed air volume cylinder 184 and an output port 185. The output of the pressure controller 182 is operatively coupled to the input of the compressed air volume cylinder 184 through a solenoid valve 186. The second pressure control stage 180 includes a solenoid valve 188 having an input port 189 connected to the output of the compressed air volume cylinder 184, and an output port 191. The output port 191 of the solenoid valve 188 is coupled to the output port 185. According to an embodiment, the output port 185 is connected, at a junction 192, to the input port 146a of the left cylinder volume 144a and to the input port 146c of right cylinder volume 144c of the gas spring cylinder 140. The solenoid valve 188 includes a pressure sensor indicated generally by reference 190. As shown in FIG. 1, the second pressure control stage 180 also includes a second solenoid valve 194 coupled to an output port on the compressed air volume cylinder 184. The solenoid valve 194 is operatively coupled to the compressed air volume cylinder 184 and configured to controllably release compressed gas to the atmosphere or to an exhaust chamber (not shown) as will be described in more detail below.

In known manner, the solenoids 182, 186, 188 and 194 are operatively coupled to the controller 122 and configured to be responsive to control signals, status request signals and other types of signals generated by the controller 122. Similarly, the pressure sensors 187 and 190 are operatively coupled to the controller 122. The sensors 187 and 190 are configured to output pressure readings and other signals to the controller 122. The pressure sensors 187 and 190 can also be configured to be responsive to sensor reading, status, reset and other control signals issued by the controller 122. The controller 122, in turn, is configured to provide the functionality and process control functions as described herein, and according to an embodiment comprises a microprocessor-based device that operates under stored program control. The implementation, programmable and configuration details are within the understanding of one skilled in the art.

According to another aspect, the controller 122 is configured to operate under stored program control (for example, execute instructions, executable code, programs or code modules in the form of firmware or software stored in memory) to sequentially control the opening and closing of the solenoids, i.e. the flow control switches, 162, 166, 168, 170 and 182, 186, 188, 194, and thereby control the routing of gas to/from the respective compressed gas volumes 164, 184 and chambers 144a, 144b, 144c in the gas spring 140 to/from the gas circuit 120 in synchronization with the movement of the pistons in the linear power generator or machine 20, and provide the other functionality and/or operational characteristics as described in further detail herein.

According to an embodiment, the gas spring system 100 is configured to operate in three modes or states: (1) system start-up; (2) system operation; and (3) system shut-down, including emergency shut-down.

In the system start-up mode, the gas spring system 100 is configured to operate under the control of the controller 122 according to an exemplary implementation as will now be described with reference to FIG. 1. The high pressure gas supply 130 is charged to a gas pressure which is approximately 10% greater than the respective gas pressures in the left 144a and right 144c chambers of the gas spring 140 and the center chamber 144b of the gas spring 140. The controller 122 is configured to calculate an appropriate gas spring charge pressure. According to an embodiment, the gas spring charge pressure is maintained in the respective pressure controls lines 163 and 183 coupled to the outputs of the respective pressure controllers (i.e. the solenoid valves) 162 and 182. The pressure controllers 162, 182 are activated by the controller 122 and set to provide the desired gas pressure values, which are sensed by the pressure sensors 167, 187 and displayed and/or outputted to the controller 122. If needed, the gas pressure values can be further adjusted under the control of the controller 122 to be within the desired tolerance levels or set point values. According to an exemplary implementation, the controller 122 is configured to activate the solenoid valves as follows:

| Pressure control line 163 | Pressure control line 183 |
|---|---|
| OPEN solenoid valve 166 | OPEN solenoid valve 186 |
| CLOSE solenoid valve 170 | CLOSE solenoid valve 194 |
| OPEN solenoid valve 168 | OPEN solenoid valve 188 |

Following this sequence, the controller 122 establishes the charge pressure in the left 144a and right 144c chambers and the center chamber 144b of the gas spring 140. The pressure sensor 169 reads the gas pressure value for the center chamber 144b and the pressure sensor 190 reads the gas pressure value for the left 144a and right 144c chambers, to confirm the respective gas pressure values are substantially the same or within a tolerance limit. In this state, the laser distance sensors 149a and 149b will also provide values for the positions of the respective pistons 142a and 142b that are substantially the same or within a give tolerance limit.

In the normal operation mode, there will be a constant pressure difference between the left 144a and right 144c chambers and the center chamber 144b in the gas spring 140. The constant pressure difference is proportional to the ratio of the active surface areas. The surface area of the center chamber or volume 144b may be defined as follows:

SA (center chamber 144b)=Dₚᵢₛₜₒₙ²*π/4

Similarly, the surface area of the left 144a and right 144c chambers may be defined as follows:

SA (left/right chambers 144a/144c)=Dₚᵢₛₜₒₙ²*π/4−D_{rod}²*π/4

It will be appreciated that as the respective gas pistons 142a and 142b traverse back and forth, the pressure in the respective chamber or volumes will change from minimum to maximum values and vice versa. The controller 122 is configured to track the pressure changes using the pressure sensor 169 (coupled to the center chamber or volume 144b) and the pressure sensor 190 (coupled to the left 144a and the right 144c chambers or volumes). According to an embodiment, the controller 122 is configured to calculate the mean pressure values in the respective left/right 144a, 144c chambers and the center chamber 144b, and if the mean pressure values exceed a threshold value or desired operating parameters, then the controller 122 is configured according to an embodiment to execute the following two control functions: (1) control function for mean pressure value is greater than desired or required pressure; and (2) control function for mean pressure value is less than desired or required pressure.

If the mean pressure value calculated by the controller 122 is greater than the desired or required pressure, then according to an embodiment, the controller 122 is configured to execute the following control functions:

CLOSE solenoid valve 166

CLOSE solenoid valve 168

OPEN solenoid valve 170

Following this control sequence, the compressed gas contained in the volume or cylinder 164 is discharged to the atmosphere or an exhaust chamber or volume through the solenoid valve 170. This serves to reduce the gas pressure in the combined volumes of the cylinder 164 and also the center volume or chamber 144b in the gas spring 140. The controller 122 is configured to return the system to normal operation by executing the following control functions:

CLOSE solenoid valve 170

CLOSE solenoid valve 166

OPEN solenoid valve 168

The controller 122 reads or inputs the new pressure value using the pressure sensor 169 and compares it against the desired or required pressure. If the adjusted pressure value is still too high, the control process described above is repeated.

If the mean pressure value calculated by the controller 122 is lower than the desired or required pressure, then the pressure controller 162 is controlled to adjust pressure to be greater in the pressure control line 163. According to an embodiment, the controller 122 is configured to execute the following control functions:

CLOSE solenoid valve 170

CLOSE solenoid valve 168

OPEN solenoid valve 166

Following this control sequence, the compressed gas (i.e. the mass) contained in the volume or cylinder 164 is increased, and this in turn will increase the gas charge pressure in the center volume or chamber 144b of the gas spring 140 once the system is returned to normal operation. The controller 122 is configured to return the system to normal operation by executing the following control functions:

CLOSE solenoid valve 170

CLOSE solenoid valve 166

OPEN solenoid valve 168

The controller 122 reads or inputs the new pressure value using the pressure sensor 169 and compares it against the desired or required pressure. If the adjusted pressure value is still lower, the control process described above is repeated.

In order to maintain balanced gas, i.e. charge, pressures between the left 144a and the right 144c volumes or chambers and the center volume 144b in the gas spring 140, the above described control process is repeated as follows.

If the mean pressure value in the left 144a and the right 144c volumes calculated by the controller 122 is greater than the desired or required pressure, then according to an embodiment, the controller 122 is configured to execute the following control functions:

CLOSE solenoid valve 186

CLOSE solenoid valve 188

OPEN solenoid valve 194

Following this control sequence, the compressed gas contained in the volume or cylinder 184 is discharged to the atmosphere or an exhaust chamber or volume through the solenoid valve 194. This serves to reduce the gas pressure in the combined volumes of the cylinder 194 and also the left 144a and the right 144c volumes or chambers in the gas spring 140. The controller 122 is configured to return the system to normal operation by executing the following control functions:

CLOSE solenoid valve 194

CLOSE solenoid valve 186

OPEN solenoid valve 188

The controller 122 reads or inputs the new pressure value using the pressure sensor 190 and compares it against the desired or required pressure. If the adjusted pressure value is still too high, the control process described above is repeated.

If the mean pressure value in the left 144a and the right 144c volumes calculated by the controller 122 is lower than the desired or required pressure, then the pressure controller 182 is controlled to adjust pressure to be greater in the pressure control line 183. According to an embodiment, the controller 122 is configured to execute the following control functions:

CLOSE solenoid valve 194

CLOSE solenoid valve 188

OPEN solenoid valve 186

Following this control sequence, the compressed gas (i.e. the mass) contained in the volume or cylinder 184 is increased (i.e. by supplying additional compressed gas from the gas supply 130), and this in turn will increase the gas charge pressure in the left 144a and right 144c volumes or chambers of the gas spring 140 once the system is returned to normal operation. The controller 122 is configured to return the system to normal operation by executing the following control functions:

CLOSE solenoid valve 194

CLOSE solenoid valve 186

OPEN solenoid valve 188

The controller 122 reads or inputs the new pressure value using the pressure sensor 190 and compares it against the desired or required pressure. If the adjusted pressure value is still lower, the control process described above is repeated.

The third mode of operation is system shut-down mode. According to an embodiment, the controller 122 is configured to execute the following control process once the pistons 142 and 142b are no longer moving, i.e. the linear motion is not detected by the sensors 149a and 149b:

CLOSE solenoid valve for pressure controller 162

CLOSE solenoid valve for pressure controller 182

CLOSE solenoid valve 166

CLOSE solenoid valve 186

OPEN solenoid valve 168

OPEN solenoid valve 188

OPEN solenoid valve 170

OPEN solenoid valve 194

Following this control process sequence, the gas charges in the center volume 144b and the left 144a and right 144c volumes of the gas spring 140 are discharged to the atmosphere or an exhaust chamber, and the gas spring 140 is effectively de-pressurized.

According to an embodiment, the controller 122 is configured to execute the shut-down mode of operation in response to an emergency condition.

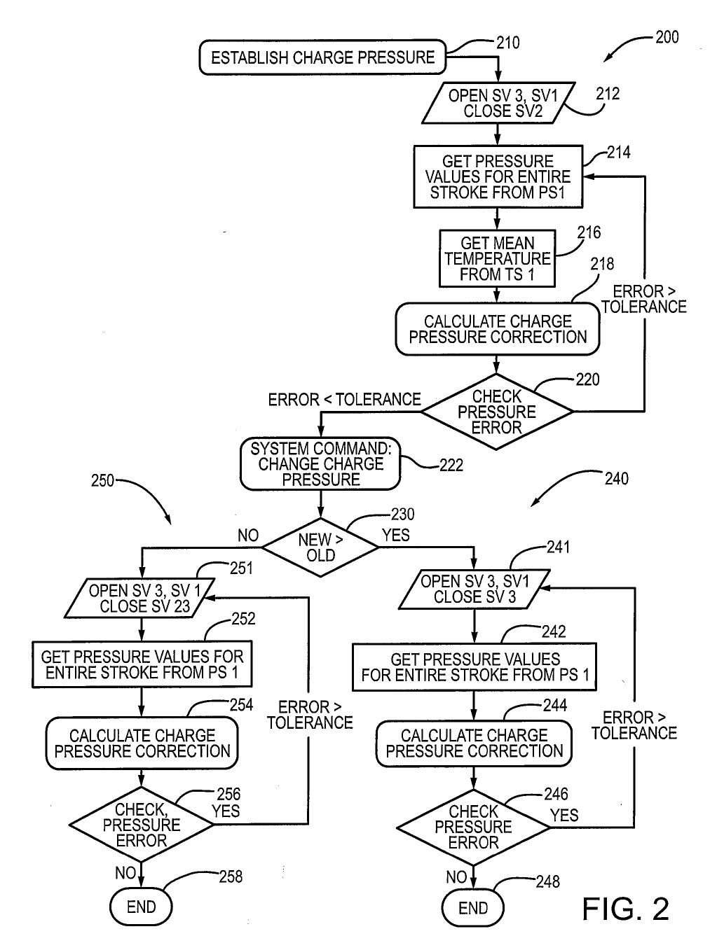

Reference is next made to FIG. 2, which shows in flowchart form a control process for controlling the gas spring 100 of FIG. 1 according to an embodiment and indicated generally by reference 200. It will be understood that the “spring action” (i.e. dampening force and rebounding force) in the gas spring 100 is generated when the pistons 142 (FIG. 1) move inside the gas spring cylinder 140 (FIG. 1) and compress/decompress the gas in the respective chambers 144a, 144b and 144c (FIG. 1). The gas pressure in the respective chambers 144a, 144b and/or 144c (FIG. 1) is further controlled by the pressure control network 120 (FIG. 1).

In accordance with an embodiment, the control process 200 comprises a process for monitoring the gas pressure(s) in the gas spring cylinder 140, i.e. the right 144a, center 144b and left 144c chambers, monitoring movement of the left 142a and the right 142b gas cylinder pistons, and controlling the pressures in the respective chambers through the actuation of the solenoids, i.e. the flow switches, 162, 166, 168, 170 and 182, 184, 188, 194. According to an embodiment, the control process 200 and associated functionality is implemented in the controller 122, for example, in the form of a microprocessor operating under stored program control.

As shown in FIG. 2, the control process 200 comprises establishing a charge pressure for the gas spring as indicated by reference 210. According to an embodiment, the charge pressure is determined by the controller 122 executing a function or software module. The next step indicated by reference 212 comprises opening the respective solenoid valves 162, 166 and 182, 184. This allows gas from the high pressure cylinder gas supply 130 to pressurize the respective compressed gas volumes or cylinders 164 and 184 (FIG. 1). In conjunction with this step, the controller 122 is configured to close the solenoid valves 170 and 194 to thereby prevent the pressurized gas from leaving the respective gas volume cylinders 164 and 184.

The next step in the control process 200 comprises monitoring the gas spring through a stroke, for example, by monitoring the outputs from the distance or movement sensors 149, and determining the pressure for the entire stroke, as indicated by reference 214. The controller 122 determines the pressure by reading or inputting pressure signals from the pressure sensor 169 (coupled to the center chamber 144b) and the pressure sensor 190 (coupled to the left 144a and the right 144c chambers), as indicated by reference 216. The control process 200 may include monitoring the mean temperature in the gas spring 140 by reading the temperature sensor 148. The temperature is monitored to ensure that the system is operating within the defined operational parameters. The temperature readings are also used for determining gas pressure values, and calculating charge pressure correction values arising from temperature changes, indicated in step 218. Next in step 220, the control process 200 determines if there is a pressure error. As described above, a pressure error can occur if the gas charge pressure in the gas spring is greater than the desired gas pressure or the system set point, or if the gas charge pressure in the gas spring is less than the desired gas pressure value or the system set point. If there is a pressure error, i.e. the error exceeds a system tolerance point or a threshold level, then the control process 200 repeats the operations in steps 214 to 218 as described above. If there is still a pressure error, the control process 200 repeats the error correction loop, otherwise, the control process continues to step 222.

As depicted in FIG. 2, the control process 200 responds to a system command to change the gas charge pressure in the gas spring as indicated in step 222. The system command can be generated, for example, in response to a condition where the gas charge pressure is greater than required, or in response to a condition where the gas charge pressure is less than required, as described above.

In response, the control process 200 determines in decision block 220 if the new gas charge pressure is to be greater than the existing gas pressure value. If yes, then the control process 200 executes a control branch to increase the gas charge pressure as indicated by reference 240. If the new gas charge pressure is less than the existing gas pressure value, then the control process 200 executes a control branch to decrease the gas charge pressure as indicated by reference 250.

As shown in FIG. 2, the gas charge pressure increase control branch 240 comprises opening and closing solenoid valves in order to increase the gas charge pressure in the gas spring, as indicted by step 241. According to an embodiment, the control process 200 is configured to open solenoid valves 166 and 168 (FIG. 1) and close solenoid valve 170 (FIG. 1), and then the control process 200 (for example, the controller 122 operating under stored program control) controls the pressure controller 162 to charge or increase the gas pressure (i.e. gas volume) in the compressed gas volume cylinder 164 (FIG. 1). The increased gas pressure is then applied to the center chamber 144b of the gas spring 140 (FIG. 1) through the solenoid 168 and effectively the gas pressure in the combined values of the cylinder 164 and the middle chamber 144b in the gas spring 140 is increased as described above. Next in step 242, the control process 200 is configured to determine the pressure values for an entire stroke, i.e. cycle of the linear power generator or machine 20. According to an embodiment, this operation comprises sampling or taking pressure value readings from the pressure sensor 169 (FIG. 1) and monitoring the stroke or cycle using the laser sensor(s) 149 (FIG. 1). The control process 200 is configured to determine if there a gas charge pressure variance between the actual gas pressure value and the desired gas pressure value (e.g. according to the system command) in step 244. Next in decision block 246, the control process 200 is configured to determine if the gas charge pressure variance exceeds a pressure error value or parameter. If yes, then the charging and calibration procedure (i.e. steps 241 to 246) is repeated. If the new gas charge pressure value exceeds the system command value, then control process 200 can be configured to execute the gas charge decrease control branch 250 as described in more detail below. According to another aspect, the charging procedure in step 241 can also include a control process for reducing the gas charge pressure if the new gas pressure value exceeds the system command value. If the pressure variance is within an acceptable range or limit, then the gas charge pressure increase process 240 ends as indicated by reference 248.

Referring again to FIG. 2, the gas charge pressure decrease control branch 250 comprises opening and closing solenoid valves in order to increase the gas charge pressure in the gas spring, as indicted by step 251. According to an embodiment, the control process 200 is configured to close solenoid valves 166 and 168 (FIG. 1) and open solenoid valve 170 (FIG. 1), and then the control process 200 (for example, the controller 122 operating under stored program control) controls the solenoid valve 170 to release or bleed gas from the compressed gas volume cylinder 164 (FIG. 1). As described above, this control process functions to reduce the gas pressure in the combined volumes of the cylinder 164 (FIG. 1) and the center volume or chamber 144b in the gas spring 140 (FIG. 1). The control process 200 in step 251 includes closing the solenoid valves 166 and 170, and opening the solenoid 168, as described above. Next in step 252, the control process 200 is configured to determine the pressure values for an entire stroke, i.e. cycle of the linear power generator or machine 20 (FIG. 1). According to an embodiment, this operation comprises sampling or taking pressure value readings from the pressure sensor 169 (FIG. 1) and monitoring the stroke or cycle using the laser sensor(s) 149 (FIG. 1). The control process 200 is configured to determine if there a gas charge pressure variance between the actual gas pressure value and the desired gas pressure value (e.g. according to the system command) in step 254. Next in decision block 256, the control process 200 is configured to determine if the gas charge pressure variance exceeds a pressure error value or parameter. If yes, then the charging and calibration procedure (i.e. steps 251 to 256) is repeated. If the new gas charge pressure value is less than the system command value, then control process 200 can be configured to execute the gas charge increase control branch 240 as described above. According to another aspect, the charging procedure in step 251 can also include a control process for increasing the gas charge pressure if the new gas pressure value exceeds the system command value. If the pressure variance is within an acceptable range or limit, then the gas charge pressure decrease process 250 ends as indicated by reference 258.

While the exemplary embodiments of the gas spring system 100 are described in the context of a two piston configuration, it will be appreciated that a single piston configuration with two chambers or volumes can be configured in accordance with another embodiment of the invention.

It will be appreciated that the gas spring system 100 as described herein can be configured and controlled to provide a dampening force and/or a rebound force which can be applied to a drive shaft configured to move linearly.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A gas spring comprising:
a cylinder;
a first piston and a second piston configured in a substantially co-axial arrangement inside said cylinder, said first piston comprising a piston face and including a rod configured to be coupled to a first movable component, and said second piston comprising a piston face and including a rod configured to be coupled to a second movable component, and said first piston being configured to move in response to movement of said first movable component, and said second piston being configured to move in response to movement of said second movable component;
said cylinder comprising first, second and third chambers;
said first chamber being defined by the volume between said first piston and an end wall of said cylinder;
said second chamber being defined by the volume between the faces of said first and said second pistons;
said third chamber being defined by the volume between said second piston and an opposing end wall of said cylinder;
said first chamber including an input port and said third chamber including an input port and said input ports being coupled to a first pressure control stage;
said second chamber including an input port and said input port being coupled to a second pressure control stage; and
a controller operatively coupled to said first and said second pressure control stages, and said controller being configured to generate one or more gas pressure forces in said first, said second or said third chambers and said gas pressure forces being applied to said first and said second pistons to vary the moving resistance of said first and said second piston rods.

2. The gas spring as claimed in claim 1, wherein said first pressure control stage comprises a pressure controller operatively coupled to said controller, and including an input port coupled to a compressed gas supply, and an output port coupled to a first compressed gas volume, said pressure controller being configured to charge said first compressed gas volume with compressed gas from said compressed gas supply, and said first compressed gas volume having an output coupled to the input ports of said first and said third chambers through another valve operatively coupled to said controller and configured to regulate the flow of compressed gas to and from said first and said third chambers.

3. The gas spring as claimed in claim 2, wherein said first pressure control stage includes a pressure sensor operatively coupled to said controller and configured to read pressure values corresponding to gas pressures in said first and said third chambers and output said pressure value readings to said controller.

4. The gas spring as claimed in claim 2, wherein said second pressure control stage comprises a pressure controller operatively coupled to said controller, and including an input port coupled to said compressed gas supply, and an output port coupled to a second compressed gas volume, said pressure controller being configured to charge said second compressed gas volume with compressed gas from said compressed gas supply, and said second compressed gas volume having an output coupled to the input port of said second chamber through another valve operatively coupled to said controller and configured to regulate the flow of compressed gas to and from said second chamber.

4. The gas spring as claimed in claim 2, wherein said first compressed gas volume include a release valve, said release valve being operatively coupled to said controller and configured to controllably release compressed gas from said first compressed gas volume.

5. The gas spring as claimed in claim 4, wherein said second pressure control stage includes a pressure sensor operatively coupled to said controller and configured to read pressure values corresponding to gas pressures in said second chamber and output said pressure value readings to said controller.

6. The gas spring as claimed in claim 1, further including a temperature sensor coupled to said cylinder and configured to take a temperature reading inside said cylinder and transmit said temperature reading to said controller, and said controller being configured to adjust said one or more gas pressure forces based on variations in said temperature readings.

7. The gas spring as claimed in claim 4, wherein said second compressed gas volume include a release valve, said release valve being operatively coupled to said controller and configured to controllably release compressed gas from said second compressed gas volume.

8. The gas spring as claimed in claim 2, wherein said pressure controller includes a pressure sensor, and a valve coupled between said output and said first compressed gas volume, and said valve being operatively coupled to isolate said first compressed gas volume, and said pressure sensor being configured to generate a pressure reading corresponding to the pressure of said compressed gas supply.

9. The gas spring as claimed in claim 1, further including a motion sensor operatively coupled to said controller and configured to sense movement of said piston rod.

10. A method for controlling a gas spring to dampen linear movement of a shaft, the gas spring comprising a cylinder and a piston configured to move linearly inside the cylinder, and the piston having a first face defining a first volume with an end wall of the cylinder and a second face defining a second volume with another end wall of the cylinder and the second face including a rod for coupling to the shaft, said method comprising the steps of:
pressurizing the first volume with a compressed gas;
pressurizing the second volume with a compressed gas;
establishing a gas charge pressure based on said pressurization of the first and second volumes; and
varying said gas charge pressure to change resistance of the piston to movement of the shaft.

11. The method as claimed in claim 10, wherein said step of varying comprises increasing said gas charge pressure to increase the resistance of the piston to movement of the shaft.

12. The method as claimed in claim 11, wherein said gas charge pressure is increased by further pressurization of the first volume with additional compressed gas.

13. The method as claimed in claim 11, wherein said gas charge pressure is increased by further pressurization of both the first and the second volumes.

14. The method as claimed in claim 10, further including the step of sensing said established gas charge pressure and adjusting said established gas charge pressure if there is a variance from a predefined value.

15. A gas spring comprising:
a cylinder;
a piston comprising a piston face and including a rod configured to be coupled to a movable component, and said piston being configured to move in response to movement of said movable component;
said cylinder comprising first and second chambers;
said first chamber being defined by the volume between said piston and an end wall of said cylinder;
said second chamber being defined by the volume between said piston and an opposing end wall of said cylinder;
said first chamber including an input port an input port and said input port being coupled to a first pressure control stage;
said second chamber including an input port and said input port being coupled to a second pressure control stage; and
a controller operatively coupled to said first and said second pressure control stages, and said controller being configured to generate one or more gas pressure forces in said first or said second chambers and said gas pressure forces being applied to said piston to vary the moving resistance of said piston rod.
